(19) United States
(12) Patent Application Publication
(10) Pub. No.: US 2025/0208564 A1
(43) Pub. Date: Jun. 26, 2025

(54) IMAGE FORMING APPARATUS AND NON-TRANSITORY COMPUTER READABLE STORAGE MEDIUM

(71) Applicant: FUJIFILM Business Innovation Corp., Tokyo (JP)

(72) Inventors: Muneyuki NISHIMURA, Kanagawa (JP); Hirotaka SATO, Kanagawa (JP); Tomohiro YAMADA, Kanagawa (JP); Masae TAKABAYASHI, Kanagawa (JP); Tomoyasu TANAKA, Kanagawa (JP)

(73) Assignee: FUJIFILM Business Innovation Corp., Tokyo (JP)

(21) Appl. No.: 18/668,276

(22) Filed: May 20, 2024

(30) Foreign Application Priority Data
Dec. 20, 2023 (JP) 2023-215206

(51) Int. Cl. G03G 21/18; G03G 21/16

(52) U.S. Cl. CPC G03G 21/1889; G03G 21/1647; G03G 2221/1838

(57) ABSTRACT

An image forming apparatus includes: an image forming unit that forms an image using an attachment body that has been attached; and a processor that performs setting for the image forming unit, the setting corresponding to the attachment body to be attached, the processor performing, in a state where the attachment body is attached, setting corresponding to another attachment body to be attached in place of an attached attachment body that is the attachment body being attached.

### CROSS-REFERENCE TO RELATED APPLICATIONS

This application is based on and claims priority under 35 USC 119 from Japanese Patent Application No. 2023-215206 filed Dec. 20, 2023.

### BACKGROUND

### (i) Technical Field

The present invention relates to an image forming apparatus and a non-transitory computer readable storage medium.

### (ii) Related Art

JP2015-145897A discloses a printing apparatus provided with a unit for displaying that a monochrome job is being submitted during toner replacement and a unit for interrupting toner replacement and permitting monochrome job printing on a device.

JP2012-511741A discloses processing of replacing a first printing module that has a high toner demand but is out of order among a plurality of printing modules with one or a plurality of second printing modules that have a low toner demand but are normal.

JP2003-271020A discloses processing of counting the number of pages printed out from the time when removal of the toner cartridge is detected, and determining that the possibility of occurrence of print fading has increased when the number of pages reaches a predetermined value.

### SUMMARY

When an attachment body such as a cartridge is replaced in an image forming apparatus, setting corresponding to a newly attached attachment body may be performed.

Here, when the setting for the newly attached attachment body is performed after the replacement of the attachment body, a situation may occur in which the timing at which the formation of an image starts is delayed by the time required for the setting.

Aspects of non-limiting embodiments of the present disclosure relate to an image forming apparatus that further shortens a time period from when an attachment body is replaced to when image formation can start as compared with a case where the attachment body is replaced and then setting for the replaced attachment body is performed.

Aspects of certain non-limiting embodiments of the present disclosure address the above advantages and/or other advantages not described above. However, aspects of the non- limiting embodiments are not required to address the advantages described above, and aspects of the non-limiting embodiments of the present disclosure may not address advantages described above.

According to an aspect of the present disclosure, there is provided an image forming apparatus comprising: an image forming unit that forms an image using an attachment body that has been attached; and a processor that performs setting for the image forming unit, the setting corresponding to the attachment body to be attached, the processor performing, in a state where the attachment body is attached, setting corresponding to another attachment body to be attached in place of an attached attachment body that is the attachment body being attached.

### BRIEF DESCRIPTION OF THE DRAWINGS

Exemplary embodiments of the present invention will be described in detail based on the following figures, wherein:

FIG. 1 is a diagram illustrating an image forming apparatus;

FIG. 2 is a diagram illustrating a configuration of an information processing unit;

FIG. 3 is a diagram illustrating a specific example of processing;

FIG. 4 is a diagram illustrating an example of another piece of processing executed in the image forming apparatus;

FIG. 5 is a flowchart illustrating an example of a flow of processing executed by a CPU;

FIG. 6A and 6B are diagrams illustrating an example of another piece of processing; and

FIG. 7 is a diagram illustrating persons related to an image forming apparatus.

### DETAILED DESCRIPTION

Hereinafter, an exemplary embodiment of the present invention will be described with reference to the accompanying drawings.

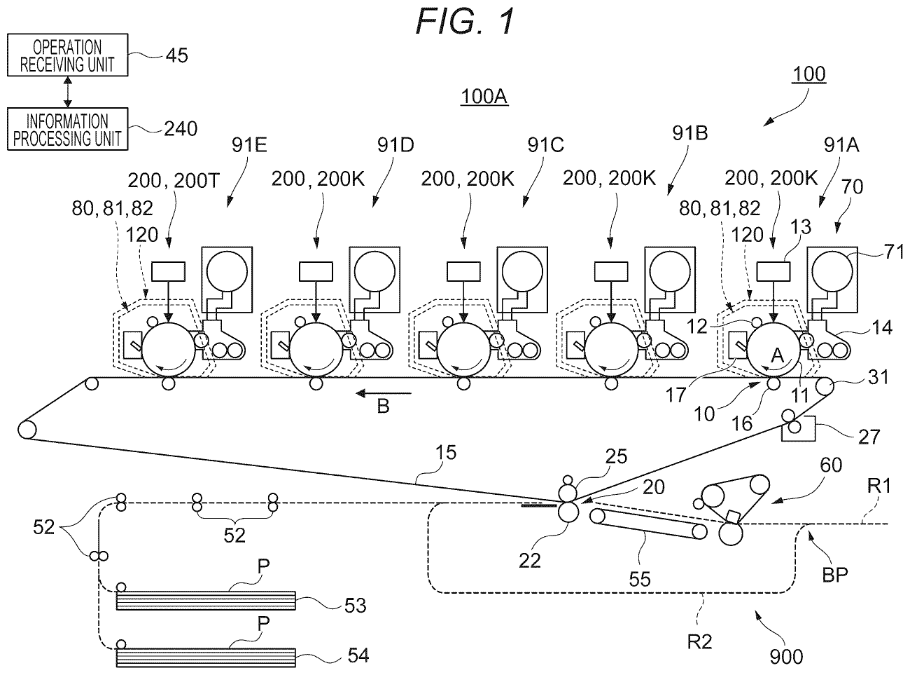

FIG. 1 is a diagram illustrating an image forming apparatus 100 according to the exemplary embodiment. FIG. 1 illustrates a state in which the image forming apparatus 100 is viewed from the front of the image forming apparatus 100.

The image forming apparatus 100 is an image forming apparatus of an intermediate transfer method called a tandem type.

The image forming apparatus 100 includes a plurality of image forming units 200 that form an image to be transferred onto a sheet P, which is an example of a recording medium. In the exemplary embodiment, five image forming units 200 are provided.

Each of the image forming units 200 as an example of an image forming means includes a photoreceptor drum 11 as an example of an image holding member.

Each of the image forming units 200 forms a toner image that is an image to be transferred onto the sheet P, on the photoreceptor drum 11 using a developer containing toner. In other words, each of the image forming units 200 forms a toner image on the photoreceptor drum 11 using a powdered developer.

The developer of the exemplary embodiment is formed of a dry carrier and a dry toner. Each of the image forming units 200 forms a toner image on the photoreceptor drum 11 using the carrier and the toner.

The five image forming units 200 form toner images on the photoreceptor drums 11 using developers of different colors.

Specifically, in the exemplary embodiment, the four image forming units 200 indicated by reference numerals 91A to 91D among the five image forming units 200 form toner images using any of developers of four colors of yellow, magenta, cyan, and black. In other words, the four image forming units 200 form toner images using the developers of the basic colors of yellow, magenta, cyan, and black.

More specifically, among the four image forming units 200, the image forming unit 200 indicated by the reference numeral 91A forms a yellow toner image using a yellow developer, and the image forming unit 200 indicated by the reference numeral 91B forms a magenta toner image using a magenta developer.

The image forming unit 200 indicated by the reference numeral 91C forms a cyan toner image by using a cyan developer, and the image forming unit 200 indicated by the reference numeral 91D forms a black toner image by using a black developer.

The remaining one image forming unit 200 indicated by the reference numeral 91E forms a toner image by using a developer of a special color that is a color other than the four colors described above, such as clear, white, gold, silver, pink, green, or orange.

Other examples of the developer for a special color include a developer including magnetic toner and a developer including conductive toner. Examples of the special color developer also include a developer including toner that emits light when irradiated with light such as ultraviolet rays or infrared rays.

In the exemplary embodiment, as the developer, a so-called two component developer in which a carrier and a toner are mixed is used, but the developer is not limited thereto, and a so-called one component developer formed only of a toner may also be used.

Each of the image forming units 200 is provided with a developing device 14.

Each of the image forming units 200 is provided with a supply device 70 that supplies a developer to the developing device 14.

The developing device 14 attaches toner, which is a developer, onto the photoreceptor drum 11, and visualizes an electrostatic latent image formed on the photoreceptor drum 11 with the toner. In other words, the developing device 14 performs development on the photoreceptor drum 11, which is an image holding member, and forms a toner image made of toner on the photoreceptor drum 11.

The supply device 70 supplies a developer to the developing device 14. Specifically, the supply device 70 supplies a developer from a toner cartridge 71 attached to the supply device 70 to the developing device 14.

The developer is formed of a carrier and a toner as described above, and the supply device 70 replenishes the developing device 14 with the carrier and the toner as the developer. In the exemplary embodiment, the carrier has a positively charged polarity and the toner has a negatively charged polarity.

Each of the image forming units 200 is provided with an attachment body 80.

Each of the image forming units 200 forms a toner image, which is an example of an image to be transferred onto the sheet P, using the attachment body 80 attached to the image forming apparatus 100.

In the exemplary embodiment, the attachment body 80 is attached to each of places where the image forming unit 200 are provided in the image forming apparatus 100.

In the exemplary embodiment, a plurality of recessed receiving part 120 are provided on an apparatus body 100A side of the image forming apparatus 100. In the exemplary embodiment, each of the image forming units 200 is provided with the receiving part 120.

In the exemplary embodiment, the attachment body 80 is attached by inserting a corresponding attachment body 80 into each of the receiving parts 120.

In the exemplary embodiment, the attachment body 80 can be attached to or detached from the receiving part 120, and is replaced with another attachment body 80 as necessary.

The attachment body 80 is prepared for each developer used in the image forming unit 200. When the developer used in the image forming unit 200 is switched to another type of developer, the attachment body 80 is also replaced.

Each attachment body 80 is formed of a plurality of constituent members. In the exemplary embodiment, the attachment body 80 includes the photoreceptor drum 11, a charging member 12, and a drum cleaner 17 as examples of the constituent members.

The attachment body 80 may include other members, and for example, the developing device 14 may also be included as a part of the attachment body. In this case, the developing device 14 is also replaced at the time of replacing the attachment body 80.

The photoreceptor drum 11 as an example of an image holding member holds a toner image to be formed as described above. The photoreceptor drum 11 rotates in a direction indicated by the arrow A.

The charging member 12 is used for charging the photoreceptor drum 11. In the exemplary embodiment, a voltage is applied between the charging member 12 and the photoreceptor drum 11 to charge the photoreceptor drum 11.

The drum cleaner 17 removes the developer remaining on the photoreceptor drum 11.

Further, in the exemplary embodiment, each of the image forming units 200 is provided with an exposure device 13.

The exposure device 13 irradiates the photoreceptor drum 11 with light to form an electrostatic latent image on the photoreceptor drum 11. The exposure device 13 includes a light source, for example, a light emitting diode (LED) and irradiates the photoreceptor drum 11 with light emitted from the light source.

The image forming apparatus 100 is provided with an intermediate transfer belt 15 to which the toner image formed by each of the image forming units 200 is transferred, and a primary transfer unit 10 that transfers the toner image formed by each of the image forming units 200 to the intermediate transfer belt 15.

The primary transfer unit 10 includes a primary transfer roller 16 that transfers the toner image formed on the photoreceptor drum 11 onto the intermediate transfer belt 15. The primary transfer unit 10 includes the primary transfer roller 16 disposed opposite the photoreceptor drum 11 with the intermediate transfer belt 15 therebetween.

Further, the image forming apparatus 100 is provided with a secondary transfer unit 20 for transferring the toner image transferred onto the intermediate transfer belt 15 onto the sheet P.

The intermediate transfer belt 15 is circularly moved at a predetermined speed in a direction of the arrow B illustrated in FIG. 1 by a drive roller 31 driven by a motor (not illustrated).

In the exemplary embodiment, the toner images on the respective photoreceptor drums 11 are sequentially and electrostatically attracted to the intermediate transfer belt 15, and superimposed toner images are formed on the intermediate transfer belt 15.

The secondary transfer unit 20 includes a secondary transfer roller 22 disposed on the outer surface side of the intermediate transfer belt 15, and a backup roller 25 disposed on the inner surface side of the intermediate transfer belt 15.

In the exemplary embodiment, at the secondary transfer unit 20, the toner image formed by the image forming unit 200 and transferred onto the intermediate transfer belt 15 is transferred onto the sheet P conveyed to the secondary transfer unit 20.

The image forming apparatus 100 is also provided with a fixing device 60 that fixes the toner image transferred onto the sheet P.

The image forming apparatus 100 is further provided with an information processing unit 240 including a CPU that executes a program. The information processing unit 240 controls each unit of the image forming apparatus 100 and performs setting of each unit.

Further, the image forming apparatus 100 is provided with an operation receiving unit 45 that receives a user operation and displays information to the user.

The operation receiving unit 45 includes, for example, a touch panel, and has not only a function of receiving a user's operation but also a function of displaying information to the user.

Further, in the exemplary embodiment, a reversing mechanism 900 that reverses the sheet P is provided.

The reversing mechanism 900 reverses the front and back of the sheet P having the toner image transferred to one side thereof in the secondary transfer unit 20, and supplies the sheet P to the secondary transfer unit 20 again. This makes it possible to form toner images on both sides of the sheet P in the exemplary embodiment.

The reversing mechanism 900 reverses the front and back of the sheet P by sending the sheet P after passing through the fixing device 60 to a branch path R2 branched from a sheet conveyance path R1.

Specifically, after the sheet P passes through a branch part BP, the reversing mechanism 900 conveys the sheet P in the reverse direction and further feeds the sheet P to the branch path R2.

The branch path R2 joins the sheet conveyance path R1 on the upstream side of the secondary transfer unit 20. Thus, in the exemplary embodiment, the sheet P in the state where the front and back are inverted is supplied again to the secondary transfer unit 20. In this case, the toner image is formed not only on one surface of the sheet P but also on the other surface, and the toner image is formed on both surfaces of the sheet P.

A flow of processing performed in the image forming apparatus 100 will be described.

The image forming apparatus 100 receives, for example, image data output from an image reading apparatus or a computer (not illustrated).

Then, image processing is performed on the image data. Through this processing, image data corresponding to each of the plurality of image forming units 200 is generated.

The generated image data is output to the exposure device 13 provided in each of the image forming units 200.

The exposure device 13 emits light to the photoreceptor drum 11 in accordance with input image data.

In the exemplary embodiment, after the surface of each photoreceptor drum 11 is charged by the charging member 12, scanning exposure is performed on the surface by the exposure device 13. Through this scanning exposure, an electrostatic latent image is formed on the surface of the photoreceptor drum 11.

Next, development treatment is performed by the developing device 14, and a toner image is formed on the photoreceptor drum 11. Then, the toner image is transferred onto the intermediate transfer belt 15 in the primary transfer unit 10.

After the toner image is transferred onto the intermediate transfer belt 15, the toner image moves to the secondary transfer unit 20 through the movement of the intermediate transfer belt 15. At this time, the sheet P from the first sheet storage portion 53 or the second sheet storage portion 54 is conveyed to the secondary transfer unit 20 by the transport roller 52 or the like.

Then, the toner images on the intermediate transfer belt 15 are collectively and electrostatically transferred onto the sheet P in the secondary transfer unit 20.

Thereafter, the sheet P having the toner image transferred thereto is released from the intermediate transfer belt 15 and is conveyed to the conveyance belt 55. The conveyance belt 55 conveys the sheet P to the fixing device 60.

The sheet P conveyed to the fixing device 60 is heated and pressurized in the fixing device 60. This causes the toner image on the sheet P to be fixed onto the sheet P. Then, the sheet P is ejected from the image forming apparatus 100.

When toner images are to be formed on both sides of the sheet P, the sheet P is again supplied to the secondary transfer unit 20 via the branch path R2 after the sheet P passes through the fixing device 60.

Then, in the secondary transfer unit 20, the toner image is transferred onto the other surface of the sheet P. Thereafter, the sheet P passes through the fixing device 60 again, and the toner image transferred to the other surface is fixed to the sheet P.

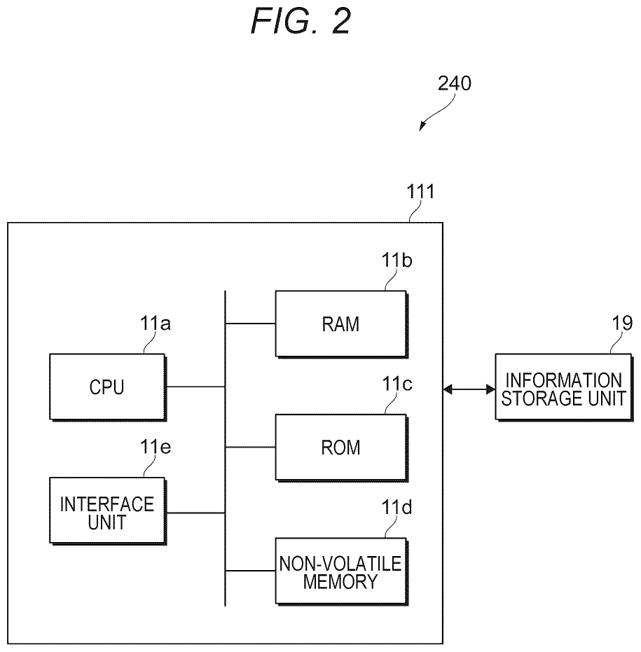

FIG. 2 is a diagram illustrating a configuration of the information processing unit 240. The information processing unit 240 is implemented by a computer.

The information processing unit 240 includes an arithmetic processing unit 111 that executes digital arithmetic processing in accordance with a program, and an information storage unit 19 that stores information.

The information storage unit 19 is implemented by an existing information storage device, for example, a hard disk drive (HDD), a semiconductor memory, or a magnetic tape.

The arithmetic processing unit 111 is provided with a CPU 11a as an example of a processor.

The arithmetic processing unit 111 is provided with a RAM 11b used as a working memory or the like of the CPU 11a and a ROM 11c in which a program or the like executed by the CPU 11a is stored.

The arithmetic processing unit 111 is provided with a non-volatile memory 11d that is configured to be rewritable and can hold date even when power supply is stopped, and an interface unit 11e that controls each unit such as a communication unit connected to the arithmetic processing unit 111.

The non-volatile memory 11d includes, for example, a battery-backed SRAM, a flash memory, or the like. The information storage unit 19 stores various types of information such as a program to be executed by the arithmetic processing unit 111.

In the exemplary embodiment, the arithmetic processing unit 111 reads a program stored in the ROM 11c or the information storage unit 19, and thus processing performed by the information processing unit 240 is executed.

The program to be executed by the CPU 11a may be provided to the information processing unit 240 in a state of being stored in a computer-readable recording medium such as a magnetic recording medium (magnetic tape, magnetic disk, or the like), an optical recording medium (optical disk or the like), a magneto-optical recording medium, or a semiconductor memory. The program to be executed by the CPU 11a may be provided to the information processing unit 240 by using communication methods such as the Internet.

In the specification, the processor refers to a processor in a broad sense, and includes general-purpose processors (for example, CPU: central processing unit) and dedicated processors (for example, GPU: graphics processing unit, ASIC: application specific integrated circuit, FPGA: field programmable gate array, and programmable logic devices).

The operation of the processor may be performed not only by one processor but also by a plurality of processors that are present at physically distant positions in cooperation with each other. The order of the operations of the processor is not limited to only the order described in the exemplary embodiment and may be changed.

### Description of Setting Processing

The setting processing performed by the CPU 11a will be described.

The CPU 11a according to the exemplary embodiment performs setting processing for the image forming unit 200 (see FIG. 1). Specifically, the CPU 11a performs a setting for the image forming unit 200, which is a setting corresponding to the attachment body 80 attached to each of the image forming units 200.

The CPU 11a performs the setting for image formation performed by the image forming unit 200 every time a new attachment body 80 is attached to the image forming unit 200, which is a setting corresponding to the attachment body 80 attached to the image forming unit 200.

This allows the image forming unit 200 to form an image by performing processing corresponding to the attachment body 80.

In the exemplary embodiment, the setting for the image forming unit 200 is performed for each attachment body 80, and the processing performed by the image forming unit 200 varies depending on the setting.

Specifically, according to the setting, for example, a driving condition of the drive unit provided in the image forming unit 200 is changed, a voltage value of the voltage to be applied in the image forming unit 200 is changed, or a current value of the current to flow in the image forming unit 200 is changed.

The CPU 11a makes, according to the attachment body 80 to be attached, settings for the image forming unit 200 to which the attachment body 80 is attached.

Specifically, in the exemplary embodiment, as will be described later, according to the attachment body 80 to be attached, processing of writing information associated with the attachment body 80 in a memory provided in association with the image forming unit 200 is performed.

In the exemplary embodiment, each attachment body 80 is provided with an information recording medium (not illustrated) in which information on the type of the attachment body 80 is stored. Further, the image forming apparatus 100 is provided with a reading unit for reading information stored in the information recording medium.

The CPU 11a specifies the type of the attachment body 80 attached to the image forming apparatus 100 based on the information read from the information recording medium.

In the exemplary embodiment, as described later, the CPU 11a makes settings corresponding to another attachment body 82 to be newly attached instead of the attached attachment body 80 (hereinafter, referred to as “attached attachment body 81”) in a state where the attachment body 80 is already attached on the image forming unit 200.

The setting corresponding to another attachment body 82 may be performed after another attachment body 82 is actually attached on the image forming apparatus 100, but in the exemplary embodiment, the setting corresponding to another attachment body 82 is performed before another attachment body 82 is actually attached on the image forming apparatus 100.

In the exemplary embodiment, in a state where the attached attachment body 81 is attached, setting corresponding to another attachment body 82 to be attached from now on instead of the attached attachment body 81 is performed.

When the setting corresponding to another attachment body 82 is performed in a state where the attached attachment body 81 is attached, image formation can resume sooner in comparison with a case where the setting corresponding to another attachment body 82 is performed after another attachment body 82 is actually attached.

In the exemplary embodiment, image formation is temporarily stopped at the time of replacement of the attachment body 80, but image formation can resume sooner by performing setting corresponding to another attachment body 82 in a state where the attached attachment body 81 is attached.

At the time of replacing the attachment body 80, the user of the image forming apparatus 100 provides an instruction to replace the attachment body 80 through the operation receiving unit 45, the user's own terminal device (not illustrated), or the like. Examples of the terminal device include a PC, a smartphone, and a tablet terminal.

When giving the replacement instruction, the user inputs information for identifying the image forming unit 200 whose attachment body 80 is to be replaced and information for identifying another attachment body 82 that is to be attached in place of the attached attachment body 81 attached on the image forming unit 200.

When the instruction to replace the attachment body 80 is received from the user, the CPU 11a starts setting corresponding to another attachment body 82 to be attached instead of the attached attachment body 81 attached at that time.

In the exemplary embodiment, in a state where the attached attachment body 81 is still attached, the setting corresponding to another attachment body 82 to be attached instead of the attached attachment body 81 starts.

### Details of Setting Processing

Details of processing for setting with CPU 11a will be described.

When performing the setting, the CPU 11a performs this setting processing in a case where there is no schedule for image formation with the image forming unit 200 using the attached attachment body 81.

In other words, the CPU 11a starts the setting processing in a case where there is no schedule for the formation of an image by the image forming unit 200 to which the attached attachment body 81 is attached.

In the exemplary embodiment, as described above, a plurality of image forming units 200 are provided, and the attachment body 80 is prepared for each of the image forming units 200.

A plurality of types of the attachment body 80 are prepared for the image forming unit 200 for a special color indicated by the reference numeral 91E in FIG. 1 (hereinafter referred to as the “special color image forming unit 200T”).

In the special color image forming unit 200T, for example, another new attachment body 82 for forming a toner image of another color is attached in place of the attached attachment body 81 which is the attachment body 80 attached until then in accordance with the demand of the user.

The CPU 11a performs setting corresponding to another attachment body 82 in a state where the attached attachment body 81 is attached in a case where there is no schedule of forming an image using the attached attachment body 81 attached at that point in time in a place where another attachment body 82 scheduled to be attached from now is to be attached.

More specifically, for example, when the image formation with the special color image forming unit 200T is not scheduled in a state where the attached attachment body 81 is attached to the special color image forming unit 200T, the CPU 11a performs setting for the special color image forming unit 200T and corresponding to another attachment body 82.

### Specific Example of Processing

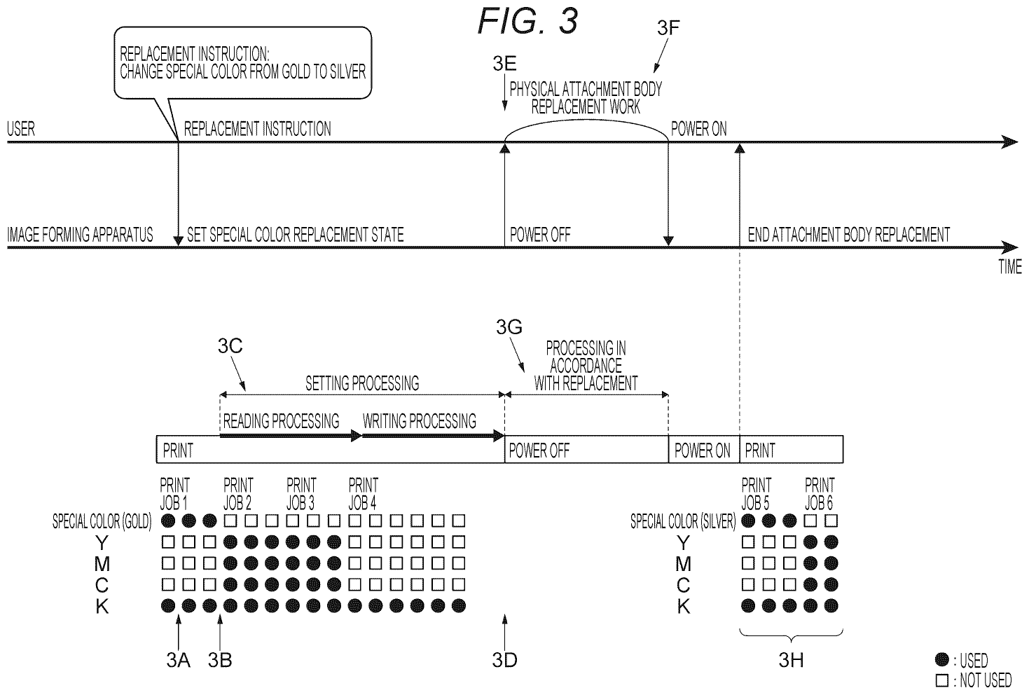

FIG. 3 is a diagram illustrating a specific example of processing.

In the specific example illustrated in FIG. 3, a case where an instruction to replace the attachment body 80 is issued from the user at a timing indicated by the reference numeral 3A is exemplified.

In this processing example illustrated in FIG. 3, a case where there is a replacement instruction to replace the attached attachment body 81 corresponding to the gold toner as an example of the attached attachment body 81 with another attachment body 82 corresponding to the silver toner as an example of another attachment body 82 is illustrated.

In this processing example, a print job 1, which is a print job using gold toner that is an example of a special color, is being executed when there is an instruction to replace the attachment body 80 from the user.

In this state, the CPU 11a does not start the setting corresponding to another attachment body 82 corresponding to the silver toner, which is an example of another attachment body 82.

Thereafter, in this processing example, at the timing indicated by the reference numeral 3B, the print job 1 using the gold toner ends. Thereafter, the print jobs subsequent to the print job 2 are brought into a state of not including the print job using the gold toner.

When the print job 1 ends, there is no schedule for image formation with the special color image forming unit 200T using the attachment body 80 corresponding to the gold toner, which is an example of the attached attachment body 81.

In this case, as indicated by the reference numeral 3C, the CPU 11a starts, for the special color image forming unit 200T, setting corresponding to the attachment body 80 corresponding to the silver toner, which is an example of another attachment body 82.

In the exemplary embodiment, information reading processing and information writing processing are performed as the setting. Details of the reading processing and the writing processing will be described later.

The special color image forming unit 200T that performs image formation using the attachment body 80 corresponding to the gold toner and the attachment body 80 corresponding to the silver toner is the special color image forming unit 200 as described above.

In the exemplary embodiment, in addition to the special color image forming unit 200T, as described above, the four image forming units 200 that form toner images using toners of the basic colors of yellow, magenta, cyan, and black, which are denoted by reference numerals 91A to 91D in FIG. 1, are provided.

Hereinafter, in the specification, each of the four image forming units 200 other than the special color image forming unit 200T is referred to as a “basic color image forming unit 200K”.

Hereinafter, in the specification, the image forming unit 200 to which an attached attachment body 81, such as the attachment body 80 corresponding to the above-described gold toner, is attached and which is in a state of using the attached attachment body 81 is referred to as a “utilization image forming unit 200”.

The utilization image forming unit 200 is in a state in which an image can be formed utilizing the attached attachment body 81.

In the processing example illustrated in FIG. 3, the CPU 11a does not perform the setting corresponding to the attachment body 80 corresponding to the silver toner when image formation is scheduled to be performed by the special color image forming unit 200T to which the attachment body 80 corresponding to the gold toner, which is an example of the attached attachment body 81, is attached.

In the exemplary embodiment, at the timing indicated by the reference numeral 3A in FIG. 3, image formation is scheduled to be performed by the special color image forming unit 200T to which the attachment body 80 corresponding to the gold toner is attached. In this case, the CPU 11a does not perform setting corresponding to the attachment body 80 corresponding to the silver toner.

The timing indicated by the reference numeral 3A in FIG. 3 is a timing when an instruction to replace the attachment body 80 is given, and the setting corresponding to the attachment body 80 corresponding to the silver toner does not start at the timing when the instruction to replace the attachment body 80 is given in the processing example illustrated in FIG. 3.

When the special color image forming unit 200T is not scheduled to form an image, the CPU 11a starts the setting corresponding to the attachment body 80 corresponding to the silver toner.

In other words, the CPU 11a starts the setting corresponding to the attachment body 80 corresponding to the silver toner when the image formation with the utilization image forming unit 200 which is the image forming unit 200 in the state where the image formation can be performed utilizing the attached attachment body 81 is not scheduled.

After the timing indicated by the reference numeral 3B in FIG. 3, no image is to be formed by the special color image forming unit 200T using the attachment body 80 corresponding to the gold toner.

In the exemplary embodiment, after the timing indicated by the reference numeral 3B in FIG. 3, the CPU 11a starts the setting corresponding to the attachment body 80 corresponding to the silver toner.

In the exemplary embodiment, even when the image formation with the basic color image forming unit 200K is scheduled to be performed when the CPU 11a receives the instruction for replacement from the user, the setting corresponding to the attachment body 80 corresponding to the silver toner is performed.

When the image formation with the special color image forming unit 200T is not scheduled, the CPU 11a performs the setting corresponding to the attachment body 80 corresponding to the silver toner even when the image formation with the basic color image forming unit 200K is scheduled.

In the example illustrated in FIG. 3, no image is to be formed by the special color image forming unit 200T after the timing indicated by the reference numeral 3B and before the timing indicated by the reference numeral 3D at which the replacement of the attachment body 80 actually starts.

On the other hand, after the timing indicated by the reference numeral 3B and before the timing indicated by the reference numeral 3D when the replacement of the attachment body 80 actually starts, the image formation with the basic color image forming unit 200K is scheduled to be performed.

In this case, in the exemplary embodiment, after the timing indicated by the reference numeral 3B, the settings for the special color image forming unit 200T and the settings corresponding to the attachment body 80 corresponding to the silver toner are performed.

In this case, in a situation where the image formation with the basic color image forming unit 200K is scheduled to be performed, the setting corresponding to the attachment body 80 corresponding to the silver toner is performed.

When the print job scheduled to be executed by the image forming apparatus 100 does not include a utilization print job which is a print job utilizing the special color image forming unit 200T which is an example of the utilization image forming unit 200, the CPU 11a performs the above-described setting corresponding to another attachment body 82.

In other words, when the print jobs to be executed by the image forming apparatus 100 do not include the utilization print job which is a print job utilizing the special color image forming unit 200T to which the attached attachment body 81 is attached, the CPU 11a starts the setting corresponding to another attachment body 82.

More specifically, when the print job to be executed by the image forming apparatus 100 does not include the utilization print job utilizing the special color image forming unit 200T to which the attachment body 80 corresponding to the gold toner is attached, the CPU 11a performs the setting corresponding to the attachment body 80 corresponding to the silver toner.

In the processing example illustrated in FIG. 3, initially, the attachment body 80 corresponding to the gold toner is attached to an intended place that is a place where the attachment body 80 corresponding to the silver toner to be attached from now on is scheduled to be attached.

The CPU 11a performs the setting corresponding to the attachment body 80 corresponding to the silver toner in a case where the print job using the attachment body 80 corresponding to the gold toner attached on the intended place is not included in the print job scheduled to be executed by the image forming apparatus 100.

At the timing indicated by the reference numeral 3A in FIG. 3, print jobs to be executed by the image forming apparatus 100 include the print job 1 that is the utilization print job utilizing the special color image forming unit 200T to which the attached attachment body 81 is attached.

In this case, the CPU 11a does not perform the setting corresponding to the attachment body 80 corresponding to the silver toner, which is another attachment body 82.

In contrast, at the timing indicated by the reference numeral 3B in FIG. 3, execution of the utilization print job utilizing the special color image forming unit 200T to which the attached attachment body 81 is attached has finished.

At the timing indicated by the reference numeral 3B in FIG. 3, the print jobs to be executed by the image forming apparatus 100 do not include the utilization print job utilizing the special color image forming unit 200T in a state of utilizing the attached attachment body 81.

In this case, the CPU 11a makes settings corresponding to the attachment body 80 corresponding to the silver toner, which is an example of another attachment body 82.

When the utilization print job is included in the print jobs scheduled to be executed by the image forming apparatus 100, the CPU 11a performs the setting corresponding to another attachment body 82 scheduled to be attached after the utilization print job is executed.

In the exemplary embodiment, when the setting processing is completed and the entire print job ends, the power of the image forming apparatus 100 is turned off as indicated by the reference numeral 3E in FIG. 3. Next, in the exemplary embodiment, as indicated by the reference numeral 3F in FIG. 3, the attachment body 80 is replaced by the user.

Specifically, the attachment body 80 corresponding to the gold toner, which is the attached attachment body 81, attached to the special color image forming unit 200T, is replaced with another attachment body 82 corresponding to the silver toner.

In the exemplary embodiment, when this physical replacement of the attachment body 80 is performed, the CPU 11a also performs internal processing in accordance with this replacement as indicated by the reference numeral 3G.

Then, the power supply of the image forming apparatus 100 is turned on, and the image formation resumes as indicated by the reference numeral 3H.

In the processing example illustrated in FIG. 3, the print job to be executed first after the resumption of the image formation is a print job 5.

The print job 5 is a print job using the attachment body 80 corresponding to the silver toner. In the processing example illustrated in FIG. 3, after the image formation resumes, the image formation using the attachment body 80 corresponding to the silver toner can be performed.

### Description of Other Processing

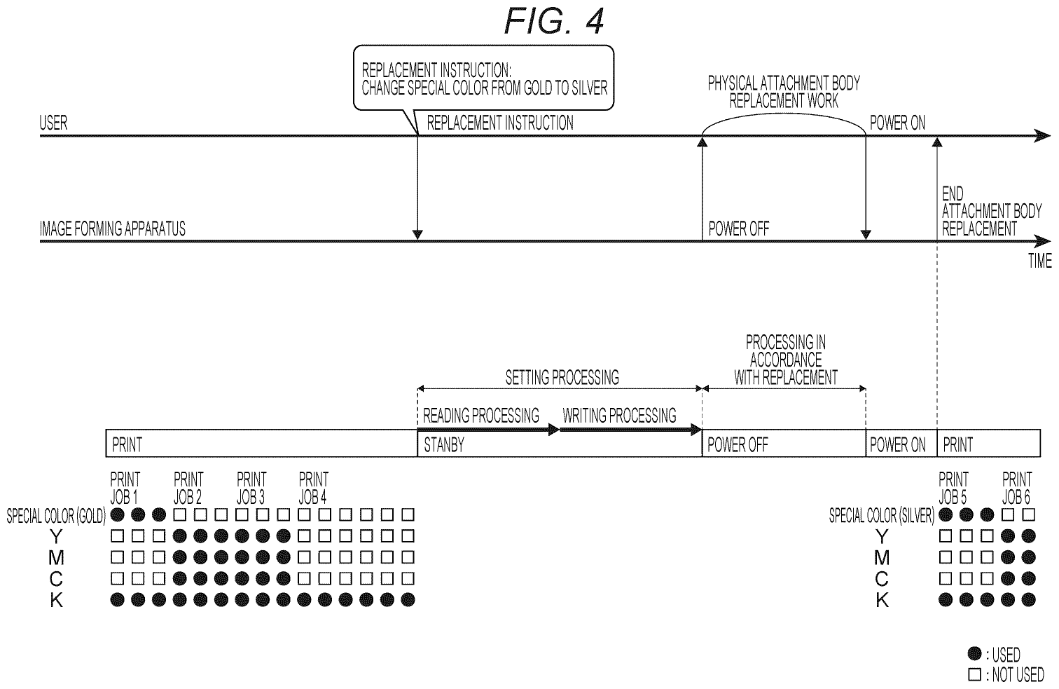

FIG. 4 is a diagram illustrating an example of another piece of processing executed in the image forming apparatus 100.

In this processing illustrated in FIG. 4, an instruction to replace the attachment body 80 from the user can be received only after all of the print jobs have ended.

Here, in the example of the processing illustrated in FIG. 3, it is possible to receive an instruction to replace the attachment body 80 from the user before the entire print job is completed.

In other words, in the processing example illustrated in FIG. 3, even with a print job that has not been executed, the screen for receiving a replacement instruction from the user is displayed on the operation receiving unit 45 or the terminal device of the user.

Thus, in the processing example illustrated in FIG. 3, a configuration has been adopted in which an instruction to replace the attachment body 80 from the user can be received before the entire print job is completed.

In contrast, in the processing example illustrated in FIG. 4, a configuration is adopted in which an instruction to replace the attachment body 80 from the user cannot be received with a print job that has not yet been executed.

In the processing example illustrated in FIG. 4, after the entire printing job is completed, the setting corresponding to another attachment body 82 to be newly attached starts.

In the example of the processing illustrated in FIG. 4, when the started setting is completed, in the same manner as described above, the power of the image forming apparatus 100 is temporarily turned off, and next, the replacement from the attached attachment body 81 to another new attachment body 82 is performed. Thereafter, the power of the image forming apparatus 100 is turned on.

Thus, also in the example of the processing illustrated in FIG. 4, an image can be formed by utilizing the special color image forming unit 200T to which another new attachment body 82 is attached.

In this processing example illustrated in FIG. 4, the time required until the print processing can resume is longer than that in the processing example illustrated in FIG. 3.

In the exemplary embodiment, the color of the image formed on the sheet P can be changed by replacing the attachment body 80.

For example, it is assumed that the attachment body 80 attached in the special color image forming unit 200T is changed from the attachment body 80 corresponding to the gold toner to the attachment body 80 corresponding to the silver toner.

In this case, the state changes from a state where an image with the basic colors and gold can be formed to a state where an image with the basic colors and silver can be formed.

When the attachment body 80 is replaced, processing is performed on both the hardware side and the software side.

Here, the hardware in the hardware side is hardware and refers to a physical device or machine. Software in the software side is software and refers to programs for giving an instruction to an electronic computer. The programs are instructions for the electronic computer and are combined so that a single result can be obtained.

In the processing on the hardware side, the user performs work of physically replacing the attachment body 80. In the processing on the hardware side, the above-described attached attachment body 81 attached to the image forming apparatus 100 is detached, and another new attachment body 82 is attached.

When colors of images formed before and after the replacement are the same, only the replacement of the developer is required, and the replacement of the attachment body 80 is not required.

On the other hand, when colors of images to be formed are different between before and after the replacement, it is necessary to perform replacement of the attachment body 80.

In a setting on the software side, for example, reading of information and writing of information are performed. In the setting on the software side, the above-described setting for the image forming unit 200 and for each attachment body 80 is performed.

With this setting on the software side, reading of information and writing of information are performed. In other words, reading of information and writing of information are performed in the above-described setting processing.

In this setting on the software side, when the attachment body 80 is replaced, first, the setting value and the adjustment value for the attached attachment body 81 which has been attached so far are read from a first memory (not illustrated) and stored in a second memory (not illustrated).

In the exemplary embodiment, information on a use history of the attached attachment body 81 is also stored in the first memory, and the information on the use history is also stored in the second memory.

The first memory and the second memory are realized by a computer-readable recording medium such as a magnetic recording medium (a magnetic tape, a magnetic disk, or the like), an optical recording medium (an optical disk or the like), a magneto-optical recording medium, or a semiconductor memory.

Thereafter, a set value and an adjustment value corresponding to another new attachment body 82 to be attached from now are read from the second memory, and the read set value and adjustment value are written in the first memory.

When this another attachment body 82 is an attachment body 80 that has already been used, information on a use history of this another attachment body 82 is also stored in the second memory. In this case, the information about the use history is also written into the first memory.

At the time of replacing the attachment body 80, the setting value or the adjustment value is also changed in accordance with the replacement of the attachment body 80.

When the attachment body 80 is replaced, the setting value and the adjustment value for the attached attachment body 81 are read from the first memory. Then, the setting value and the adjustment value for another new attachment body 82 to be attached are written in the first memory.

In the exemplary embodiment, the first memory provided corresponding to each of the image forming units 200 and the second memory that is common for them and different from the first memory is provided. The second memory has a capacity larger than that of the first memory.

The above-described setting values and adjustment values corresponding to the respective attachment bodies 80 are stored in the second memory in advance.

When the attachment body 81 is replaced with another new attachment body 82, the setting value and the adjustment value corresponding to the attached attachment body 81 are read from the first memory and stored in the second memory. The information on the use history is also read from the first memory and stored in the second memory.

Next, the setting value and the adjustment value corresponding to another attachment body 82 to be newly attached are read from the second memory and stored in the first memory. As described above, when there is information on the use history, the information on the use history is also read from the second memory and stored in the first memory.

When another new attachment body 82 is attached, the information stored in the first memory changes. Thus, the content of processing performed at the image forming unit 200 to which the new another attachment body 82 is attached changes.

It often takes time to transfer information between the first memory and the second memory. When the delivery of the information is performed after all of the print jobs are completed, it takes a long time to resume the image formation.

In contrast, in the exemplary embodiment, as described above, regarding the processing on the software side, when the special color image forming unit 200T is not scheduled to be used, the processing on the software side starts even with another print job that utilizes the basic color image forming unit 200K.

Thus, before all the print jobs are completed, the processing on the software side starts, and accordingly, the image formation can resume sooner.

### Description of Series of Processing

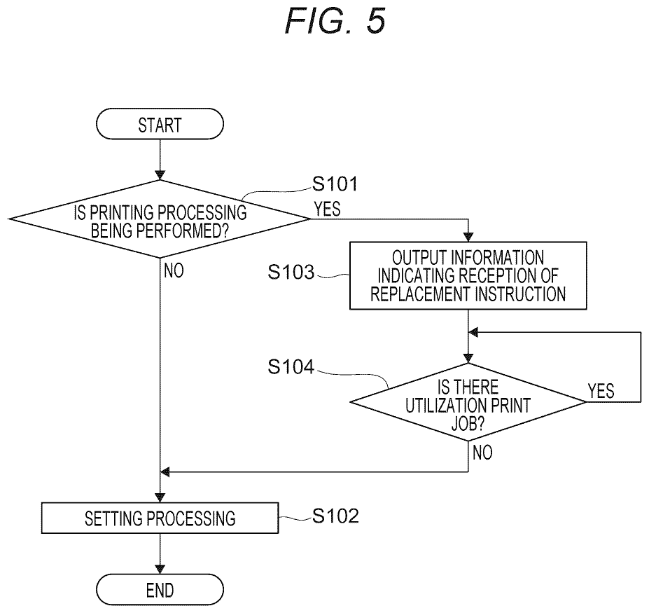

FIG. 5 is a flowchart illustrating an example of the flow of processing executed by the CPU 11a.

FIG. 5 illustrates a flow of processing after an instruction to replace the attachment body 80 is received from the user.

When there is a replacement instruction from the user, the CPU 11a determines whether print processing is being performed in the image forming apparatus 100 (Step S101).

In other words, when there is a replacement instruction from the user, the CPU 11a determines whether there is a print job that has not yet been executed.

Then, when the CPU 11a does not determine that print processing is being performed on the image forming apparatus 100, the CPU 11a performs the above-described setting processing (Step S102). In other words, the CPU 11a starts the above-described setting processing when there is no print job scheduled to be executed.

On the other hand, when the CPU 11a determines in Step S101 that print processing is being performed in the image forming apparatus 100, the CPU 11a outputs information indicating that an instruction for replacement has been received from the user (Step S103).

Thus, in the exemplary embodiment, information indicating that the instruction for replacement has been received is displayed on the operation receiving unit 45 (see FIG. 1) or the terminal device of the user.

Next, the CPU 11a determines whether any of the print jobs to be executed is the utilization print job utilizing the image forming unit 200 to which the attached attachment body 81 is attached (Step S104).

Then, when the CPU 11a determines that there is no utilization print job in the print jobs to be executed, the CPU 11a executes the processing of Step S102 and performs the processing of the setting described above.

On the other hand, when the CPU 11a does not determine in Step S104 that there is no utilization print job in the print jobs scheduled to be executed, the CPU 11a executes the processing in Step S104 again.

### Other Processing Examples

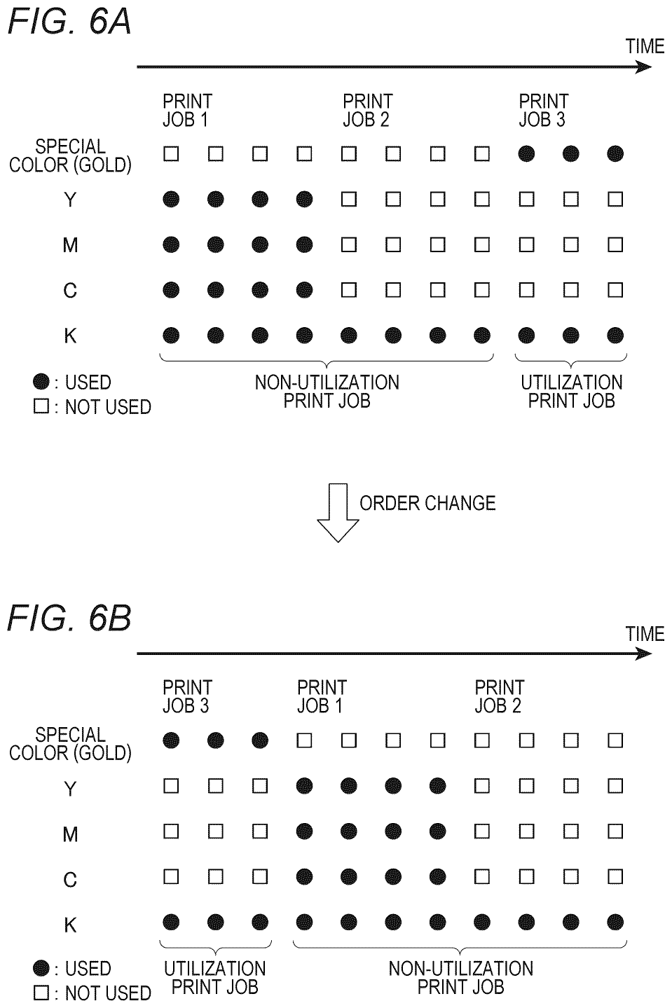

FIGS. 6A and 6B are diagrams illustrating an example of other processing.

In this processing example illustrated in FIG. 6, as illustrated in FIG. 6A, at first, the non-utilization print job is scheduled to be executed prior to the utilization print job.

As described above, the utilization print job refers to a print job that utilizes the special color image forming unit 200T in a state of using the attached attachment body 81, such as the print job 3. In other words, the utilization print job refers to a print job utilizing the image forming unit 200 to which the attached attachment body 81 is attached.

In contrast, the non-utilization print job refers to a print job that does not utilize the special color image forming unit 200T in a state where the attached attachment body 81 is used, such as the print job 1 or the print job 2. In other words, the non-utilization print job refers to a print job that does not utilize the image forming unit 200 to which the attached attachment body 81 is attached.

In the processing example illustrated in FIG. 6A, print jobs to be executed by the image forming apparatus 100 include the utilization print job and the non-utilization print job.

In the processing example illustrated in FIG. 6A, the non-utilization print job is executed before the utilization print job.

In this case, the CPU 11a changes the execution order of the print jobs so that, as illustrated in FIG. 6B, the utilization print job is executed before the non-utilization print job.

In this processing example, when there is an instruction to replace the attachment body 80 from the user, the CPU 11a changes the order of execution of the print jobs. As a result, as illustrated in FIG. 6B, the utilization print job is executed before the non-utilization print job.

When the execution order of the print jobs is changed, the CPU 11a performs setting corresponding to another attachment body 82 scheduled to be attached after the utilization print job is executed, in the same manner as described above.

In this case, the setting corresponding to another attachment body 82 can start sooner than in a case where the order of the print jobs is not changed, and thus the image formation can resume sooner.

### Information Output Processing

Next, information output processing will be described.

In a case of performing the above-described setting corresponding to another attachment body 82, the CPU 11a performs processing of outputting information indicating that image formation cannot be performed by utilizing the image forming unit 200 to which the attached attachment body 81 is attached.

More specifically, when performing the above-described setting corresponding to another attachment body 82, the CPU 11a performs, for example, processing for outputting information indicating that image formation cannot be performed utilizing the special color image forming unit 200T.

As a result, in the exemplary embodiment, information indicating that an image cannot be formed by utilizing the special color image forming unit 200T is displayed on the operation receiving unit 45 or a device operated by the user.

Thus, the user recognizes that image formation cannot be performed using the special color.

In the exemplary embodiment, even after an instruction to replace the attachment body 80 is given by the user, the user can give an instruction to the image forming apparatus 100 to form an image by using the attached attachment body 81.

In other words, in the exemplary embodiment, even after an instruction to replace the attachment body 80 is provided by the user, the user can provide the image forming apparatus 100 with an instruction to form an image using the special color.

As described above, when the information indicating that image formation cannot be performed by utilizing the image forming unit 200 to which the attached attachment body 81 is attached is output, the utilization print job utilizing the attached attachment body 81 is prevented from being output to the image forming apparatus 100.

More specifically, output of the utilization print job utilizing the attached attachment body 81 to the image forming apparatus 100 from the print orderer described later is suppressed.

### Description of Persons Related to Image Forming Apparatus 100

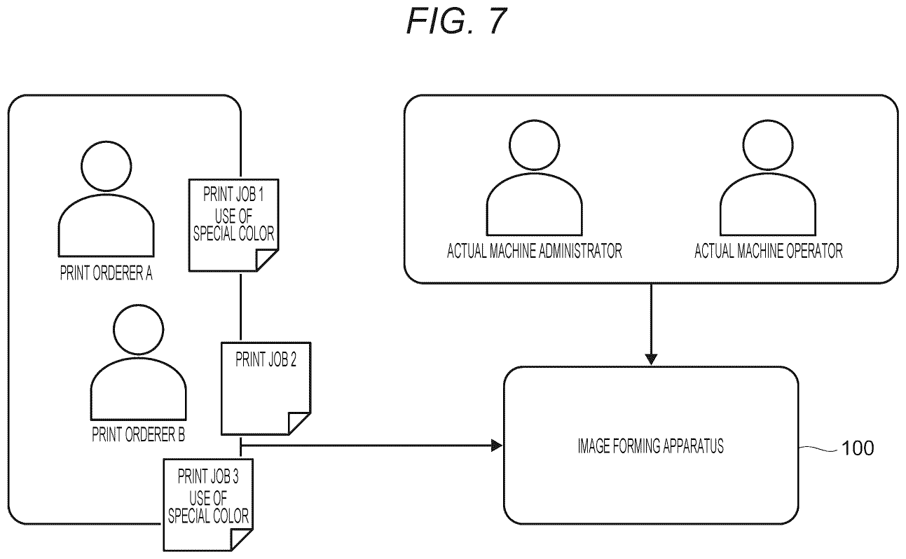

FIG. 7 is a diagram illustrating persons related to the image forming apparatus 100.

Various persons are related to the image forming apparatus 100, and FIG. 7 illustrates an example of persons related to the image forming apparatus 100. Persons related to the image forming apparatus 100 include, for example, a print orderer, an actual machine administrator, and an actual machine operator.

The print orderer is a person who wants to obtain a printed matter and who outputs a print job to the image forming apparatus 100. The print orderer is not limited to one person, and may be a plurality of persons.

The actual machine administrator is a responsible person who manages the image forming apparatus 100.

The actual machine operator is a person who performs work on the image forming apparatus 100. The actual machine operator replenishes the image forming apparatus 100 with sheet P, toner, or the like. The actual machine operator performs toner replacement and test printing. The actual machine operator also performs the replacement work of the attachment body 80.

Here, it is assumed that the actual machine administrator (see FIG. 7) gives an instruction to replace the attachment body 80 via the operation receiving unit 45 (see FIG. 1) or the terminal device during the execution of the print job 1 illustrated in FIG. 3.

In this case, in the exemplary embodiment, during the execution of the print job 1, information indicating that image formation cannot be performed utilizing the image forming unit 200 to which the attached attachment body 81 is attached is displayed on the operation receiving unit 45 and the terminal device of the print orderer.

Specifically, for example, a display indicating that “the attachment body 80 is being replaced” is provided. Thus, a print orderer other than the person who has issued the instruction to replace the attachment body 80 also knows that the attachment body 80 will be replaced.

Here, the case where the information indicating that the attachment body 80 is being replaced is output and displayed as the information indicating that image formation cannot be performed by utilizing the image forming unit 200 to which the attached attachment body 81 is attached has been described as an example.

However, the present invention is not limited to this configuration, but for example, information indicating that image formation with a special color cannot be performed may be output, and this information indicating that image formation with a special color cannot be performed may be displayed on the operation receiving unit 45 or the terminal device of the print orderer.

According to the above-described processing, in the exemplary embodiment, it is less likely that the print orderer erroneously gives an instruction for image formation based on the print job using a special color.

In the exemplary embodiment, when the replacement of the attachment body 80 is completed, the CPU 11a outputs information indicating that the replacement is completed. Thus, information indicating that the replacement of the attachment body 80 has been completed is displayed on the operation receiving unit 45 and the terminal device of the print orderer.

### Other Processing

The CPU 11a may be configured not to execute the utilization print job when the image forming apparatus 100 receives the utilization print job utilizing the image forming unit 200 to which the attached attachment body 81 is attached after starting the setting corresponding to the above-described another attachment body 82.

The print job output to the image forming apparatus 100 also includes information about the toner to be used. The CPU 11a may be configured not to execute the print job when the color of the toner specified by the information on the toner matches the color associated with the attached attachment body 81.

Not executing the utilization print job that utilizes the image forming unit 200 to which the attached attachment body 81 is attached suppresses occurrence of a failure such as formation of an image unintended by the user.

In the exemplary embodiment, the image forming apparatus 100 is configured to be able to receive the utilization print job even after starting the setting corresponding to another attachment body 82. In this case, formation of an image based on the utilization print job may be performed after the start of the setting corresponding to another attachment body 82, and an image not intended by the user may be formed.

In this case, when the utilization print job is prevented from being executed, a problem that an image not intended by the user is formed is less likely to occur.

In addition, when the image forming apparatus 100 receives the utilization print job after the CPU 11a starts the setting corresponding to another attachment body 82, the utilization print job may be prevented from being executed and the utilization print job may be stored in the information storage unit 19 (see FIG. 2).

Further, when another attachment body 82 is attached in place of the attached attachment body 81 and thus the attached attachment body 81 that has been detached is attached to the image forming unit 200 again, the CPU 11a may cause the utilization print job stored in the information storage unit 19 to be executed.

It is also assumed that after the attached attachment body 81 is temporarily detached from the special color image forming unit 200T, the attached attachment body 81 is attached to the special color image forming unit 200T again.

In this case, as described above, when a configuration is adopted in which the utilization print job is stored in the information storage unit 19, the utilization print job can be executed when the attached attachment body 81 is attached to the special color image forming unit 200T again.

In this case, even when the user does not newly give an instruction for image formation based on the utilization print job, image formation based on the utilization print job starts.

In the above description, a case where the setting corresponding to another attachment body 82 is performed during the execution of the non-utilization print job has been described as an example. In other words, a case where the processing on the software side is performed during the execution of the non-utilization print job has been described above.

The present invention is not limited to this configuration, and a configuration may be adopted in which processing for the hardware side can also be performed during execution of the non-utilization print job. More specifically, a configuration may be adopted in which replacement from the attached attachment body 81 to another attachment body 82 can be performed during execution of the non-utilization print job.

In the case of a configuration in which processing on the hardware side can also be performed during execution of the non-utilization print job, information indicating that the attachment body 80 can be replaced is output from the CPU 11a.

Thus, information indicating that the attached attachment body 81 can be replaced with another attachment body 82 is displayed on the operation receiving unit 45 or a terminal device.

In this case, the user performs replacement from the attached attachment body 81 to another attachment body 82 during execution of the non-utilization print job.

In the case of a configuration in which processing on the hardware side can also be performed during execution of the non-utilization print job, processing such as stopping of power feeding to the image forming unit 200 to which the attached attachment body 81 is attached is performed.

In other words, in the case of a configuration in which processing on the hardware side can be performed during execution of the non-utilization print job, the state of the image forming unit 200 to which the attached attachment body 81 is attached is set to a state in which removal of the attached attachment body 81 by the user can be performed.

In the case of a configuration in which the processing for the hardware side can be performed during the execution of the non-utilization print job, the state of the image forming unit 200 after the attached attachment body 81 is detached is set to a state in which the user can newly attach another attachment body 82.

When the processing for the hardware side can also be performed during the execution of the non-utilization print job, the resumption of the image formation after the replacement of the attachment body 80 can be performed sooner than in a configuration in which only the processing for the software side can be performed.

The above-described configuration and processing may be applied to a so-called monochrome machine in which only one image forming unit 200 is provided.

In the monochrome machine, when there is an instruction to replace the attachment body 80 from the user and there is no schedule to form an image with the image forming unit 200, setting corresponding to another new attachment body 82 is performed.

### (Supplementary Note)

An image forming apparatus comprising:
an image forming unit that forms an image using an attachment body that has been attached; and
a processor that performs setting for the image forming unit, the setting corresponding to the attachment body to be attached, the processor performing, in a state where the attachment body is attached, setting corresponding to another attachment body to be attached in place of an attached attachment body that is the attachment body being attached.
   (((2)))

The image forming apparatus according to (((1))),
wherein the processor performs the setting corresponding to the another attachment body when there is no schedule to form an image with the image forming unit to which the attached attachment body is attached.
   (((3)))

The image forming apparatus according to (((1))),
wherein
a plurality of the image forming units are provided,
the attachment body is attached to each of the image forming units, and
the processor performs the setting corresponding to the another attachment body when there is no schedule to form an image by using the attached attachment body that is attached to a place where the another attachment body is to be attached.
   (((4)))

The image forming apparatus according to (((3))),
wherein the processor performs the setting corresponding to the another attachment body even when there is a schedule to form an image with another image forming unit other than the image forming unit to which the attached attachment body is attached.
   (((5)))

The image forming apparatus according to (((1))), wherein
a plurality of the image forming units are provided,
the attachment body is attached to each of the image forming units, and
the processor performs the setting corresponding to the another attachment body when a utilization print job that is a print job utilizing the attached attachment body is not included in print jobs to be executed by the image forming apparatus.
   (((6)))

The image forming apparatus according to (((5))),
wherein when the utilization print job is included in the print jobs to be executed by the image forming apparatus, the processor performs the setting corresponding to the another attachment body after the utilization print job is executed.
   (((7)))

The image forming apparatus according to (((6))),
wherein when a non-utilization print job that is a print job that is executed prior to the utilization print job and does not utilize the attached attachment body is included, in addition to the utilization print job, in the print jobs to be executed by the image forming apparatus, the processor changes an order of execution of the print jobs to cause the utilization print job to be executed prior to the non-utilization print job.
   (((8)))

The image forming apparatus according to (((1))),
wherein when the processor performs the setting corresponding to the another attachment body, the processor outputs information indicating that image formation cannot be performed by utilizing the image forming unit to which the attached attachment body is attached.
   (((9)))

The image forming apparatus according to (((1))),
wherein when the image forming apparatus receives a utilization print job that is a print job utilizing the attached attachment body after starting the setting corresponding to the another attachment body, the processor prevents the utilization print job from being executed.
   (((10)))

The image forming apparatus according to (((9))),
wherein the processor causes the utilization print job not to be executed and causes the utilization print job to be stored in an information storage unit provided in the image forming apparatus.
   (((11)))

The image forming apparatus according to (((10))),
wherein the processor causes the utilization print job stored in the information storage unit to be executed when the attached attachment body that has been removed in association with attachment of the another attachment body in place of the attached attachment body is attached again.
   (((12)))

A non-transitory computer readable storage medium storing a program to be executed by a computer provided in an image forming apparatus,
the image forming apparatus comprising an image forming unit that forms an image by using an attachment body that has been attached, the program causing the computer provided in the image forming apparatus to implement a function of performing setting for the image forming unit and corresponding to the attachment body to be attached, the function of performing, in a state where the attachment body is attached, setting corresponding to another attachment body to be attached in place of an attached attachment body that is the attachment body being attached.

What is claimed is:

1. An image forming apparatus comprising:
an image forming unit that forms an image using an attachment body that has been attached; and
a processor that performs setting for the image forming unit, the setting corresponding to the attachment body to be attached, the processor performing, in a state where the attachment body is attached, setting corresponding to another attachment body to be attached in place of an attached attachment body that is the attachment body being attached.

2. The image forming apparatus according to claim 1,
wherein the processor performs the setting corresponding to the another attachment body when there is no schedule to form an image with the image forming unit to which the attached attachment body is attached.

3. The image forming apparatus according to claim 1, wherein
a plurality of the image forming units are provided,
the attachment body is attached to each of the image forming units, and
the processor performs the setting corresponding to the another attachment body when there is no schedule to form an image by using the attached attachment body that is attached to a place where the another attachment body is to be attached.

4. The image forming apparatus according to claim 3,
wherein the processor performs the setting corresponding to the another attachment body even when there is a schedule to form an image with another image forming unit other than the image forming unit to which the attached attachment body is attached.

5. The image forming apparatus according to claim 1, wherein
a plurality of the image forming units are provided,
the attachment body is attached to each of the image forming units, and
the processor performs the setting corresponding to the another attachment body when a utilization print job that is a print job utilizing the attached attachment body is not included in print jobs to be executed by the image forming apparatus.

6. The image forming apparatus according to claim 5,
wherein when the utilization print job is included in the print jobs to be executed by the image forming apparatus, the processor performs the setting corresponding to the another attachment body after the utilization print job is executed.

7. The image forming apparatus according to claim 6,
wherein when a non-utilization print job that is a print job that is executed prior to the utilization print job and does not utilize the attached attachment body is included, in addition to the utilization print job, in the print jobs to be executed by the image forming apparatus, the processor changes an order of execution of the print jobs to cause the utilization print job to be executed prior to the non-utilization print job.

8. The image forming apparatus according to claim 1,
wherein when the processor performs the setting corresponding to the another attachment body, the processor outputs information indicating that image formation cannot be performed by utilizing the image forming unit to which the attached attachment body is attached.

9. The image forming apparatus according to claim 1,
wherein when the image forming apparatus receives a utilization print job that is a print job utilizing the attached attachment body after starting the setting corresponding to the another attachment body, the processor prevents the utilization print job from being executed.

10. The image forming apparatus according to claim 9,
wherein the processor causes the utilization print job not to be executed and causes the utilization print job to be stored in an information storage unit provided in the image forming apparatus.

11. The image forming apparatus according to claim 10,
wherein the processor causes the utilization print job stored in the information storage unit to be executed when the attached attachment body that has been removed in association with attachment of the another attachment body in place of the attached attachment body is attached again.

12. A non-transitory computer readable storage medium storing a program to be executed by a computer provided in an image forming apparatus,
the image forming apparatus comprising an image forming unit that forms an image by using an attachment body that has been attached, the program causing the computer provided in the image forming apparatus to implement a function of performing setting for the image forming unit and corresponding to the attachment body to be attached, the function of performing, in a state where the attachment body is attached, setting corresponding to another attachment body to be attached in place of an attached attachment body that is the attachment body being attached.
